(19) United States
(12) Patent Application Publication
(10) Pub. No.: US 2019/0278140 A1
(43) Pub. Date: Sep. 12, 2019

(54) METHOD FOR PRODUCING SUBSTRATE PROVIDED WITH ALIGNMENT FILM

(71) Applicant: SHARP KABUSHIKI KAISHA, Sakai City (JP)

(72) Inventors: KOHSHIROH TANIIKE, Sakai City (JP); RYOSUKE YUMINAMI, Sakai City (JP)

(21) Appl. No.: 16/291,704

(22) Filed: Mar. 4, 2019

(30) Foreign Application Priority Data
Mar. 6, 2018 (JP) 2018-039777

(51) Int. Cl. G02F 1/1337; C09K 19/54

(52) U.S. Cl. CPC G02F 1/133711; G02F 1/133723; C09K 2219/03; C09K 2019/548; C09K 19/542

(57) ABSTRACT

The present invention provides a method for producing a substrate provided with an alignment film whose refractive index anisotropy is less likely to change and can be maintained at a high level even during long-term use. The method for producing a substrate provided with an alignment film includes: a film coating step in which an alignment film composition is applied to a surface of a substrate to form a film, the alignment film composition containing a first polymer that contains an azobenzene group in a main chain thereof; and a heating and exposure step in which the film is irradiated with light while the substrate is heated at 60° C. to 80° C. The light applied in the heating and exposure step is preferably within a wavelength range of 320 to 500 nm.

### CROSS-REFERENCE TO RELATED APPLICATIONS

The present application claims priority under 35 U.S.C. § 119 to Japanese Patent Application No. 2018-039777 filed on Mar. 6, 2018, the contents of which are incorporated herein by reference in their entirety.

### BACKGROUND OF THE INVENTION

### Field of the Invention

The present invention relates to a method for producing a substrate provided with an alignment film.

### Description of Related Art

Liquid crystal display devices that provide display by controlling the alignment of liquid crystal molecules in a liquid crystal layer enclosed between paired substrates usually have alignment films between the respective substrates and the liquid crystal layer. These alignment films can control the alignment azimuth and pre-tilt angle of adjacent liquid crystal molecules. Such a force of controlling the properties such as the alignment azimuth of liquid crystal molecules, i.e., an alignment controlling force, can be obtained by an alignment treatment technique such as a rubbing technique or a photo-alignment technique.

The photo-alignment technique is a highly stable technique capable of aligning liquid crystal molecules at high precision, and is being widely expanded as an alignment treatment technique taking the place of the rubbing technique. In contrast, in consideration of productivity, the photo-alignment technique requires higher initial investment and a longer treatment time than the rubbing technique. In the case of the rubbing technique in which a surface of an alignment film is rubbed with a cloth, for example, the treatment time may be reduced by increasing the amount of hair to contact with the alignment film or by increasing the number of rotations of a rubbing roll. In contrast, the photo-alignment technique in which polarized light is applied to an alignment film material requires development of highly sensitive materials or process techniques enabling effective reactions so as to reduce the treatment time (for example, see JP H11-218765 A, WO 2016/017535, and JP 2017-142453 A).

JP H11-218765 A discloses an alignment method for a polymer film. The method includes applying linearly polarized light to a polymer film, which has a moiety capable of being aligned by linearly polarized light and has a glass transition temperature of 200° C. or higher, with the alignable moiety being in an easily movable state. This easily movable state of the alignable moiety is achieved by heating.

WO 2016/017535 discloses a liquid crystal display device including, in the following order from a back surface side: a backlight that emits light including visible light; a linear polarizer; a first substrate; an alignment film; a liquid crystal layer that contains liquid crystal molecules; and a second substrate. The alignment film contains a material with an azobenzene structure that exhibits absorption anisotropy for visible light and isomerizes upon absorption of visible light. The linear polarizer has a polarized light transmission axis that intersects a direction in which the alignment film has larger absorption anisotropy.

JP 2017-142453 A discloses a method for manufacturing a substrate including a liquid crystal alignment film. The method includes the steps of: [I] applying a polymer composition, containing (A) a photosensitive side chain type polymer exhibiting liquid crystallinity within a predetermined temperature range and (B) an organic solvent, onto a substrate including a conductive film for lateral electric field driving to form a coating film; [II] irradiating the coating obtained in the step [I] with polarized ultraviolet light while heating the coating at a temperature equal to or higher than 35° C. and lower than the Tiso of the photosensitive side chain type polymer; and [III] heating the coating obtained in the step [II]. Thereby, the method can provide a liquid crystal alignment film for a lateral electric field driven liquid crystal display element with an alignment controlling ability.

### BRIEF SUMMARY OF THE INVENTION

Liquid crystal display devices are tested before shipment under conditions close to the most severe environment in practical use, whereby the quality is checked. Liquid crystal display devices are used in a variety of applications, and these applications and use environments require different qualities. For example, onboard liquid crystal display devices are used for a longer period of time than mobile liquid crystal display devices to be used in devices such as smartphones and tablet PCs, and thus need to have long-term reliability that enables long-term use. Further, such onboard liquid crystal display devices are supposed to be used in high-temperature environments, and thus need to have excellent long-term reliability at high temperature. The long-term reliability at high temperature may be evaluated by a test such as a thermal shock test or a long-term image sticking test. In the thermal shock test, the temperature of a liquid crystal panel constituting a liquid crystal display device is changed to a low temperature and to a high temperature at a constant cycle, so that a load due to the temperature change is applied. In the long-term image sticking test, a liquid crystal panel heated at a high temperature of about 80° C., for example, is irradiated with light from a backlight for a long time.

The alignment film to be allowed to exhibit an alignment controlling force by the photo-alignment technique may be formed from a polymer containing a photo-reactive moiety. In some studies performed by the present inventors, the presence of a polymer containing a decomposable type photo-reactive moiety as a material of the alignment film led to generation of decomposition products by the photo-alignment treatment and the decomposition products were observed as bright dots. Since onboard liquid crystal display devices are used within a wide temperature range in an actual use environment, the temperature range applied in the thermal shock test is also wide. For example, the temperature may be raised and lowered between −40° C. and 85° C. Such a temperature range causes repeat of significant shrinkage and expansion of the liquid crystal material. The volume thereof may vary even about 10% in some cases. Repeat of shrinkage and expansion of the liquid crystal material in the thermal shock test seems to cause aggregation of the decomposition products which had been dissolved in the liquid crystal layer during production, and the aggregates are observed as bright dots.

Then, the present inventors examined how to reduce generation of bright dots in the thermal shock test. As a result, they found that a polymer containing, as a photo-reactive moiety, an azobenzene group that is isomerized by light irradiation will not generate decomposition products even when irradiated with light such as ultraviolet light in the photo-alignment technique and thus can prevent generation of bright dots itself. In contrast, although an alignment film composition containing a polymer having an azobenzene group used as an alignment film material will not generate decomposition products by application of light such as ultraviolet light and thus can prevent bright dots, the resulting alignment film may have a reduced alignment controlling force in the long-term image sticking test in some cases.

The present invention is made in view of the above state of the art, and aims to provide a method for producing a substrate provided with an alignment film whose refractive index anisotropy is less likely to change and can be maintained at a high level even during long-term use.

The present inventors examined the causes of reduction in alignment controlling force of an alignment film that contains a polymer containing an azobenzene group in the long-term image sticking test. FIG. 9 is a graph of comparison of the absorbances of alignment films. In FIG. 9, “A” represents the absorbance of an alignment film that contains a polymer containing an azobenzene group and “B” represents the absorbance of an alignment film that contains a polymer containing a decomposable type photo-reactive moiety. The alignment film B used as an example was an alignment film whose main wavelength for photo reaction is 254 nm. FIG. 9 shows that the alignment film B that contains a polymer containing a decomposable type photo-reactive moiety exhibits no absorption in the visible light region, while the alignment film A that contains a polymer containing an azobenzene group has a reaction region ranging broadly to the visible light region.

The light applied from a backlight (backlight illumination) contains visible light within the absorption wavelength range of the alignment film A. Thus, when an unreacted azobenzene group is present in the alignment film A, the backlight illumination causes a reaction of the unreacted azobenzene group and the refractive index anisotropy of the alignment film A decreases over time. Accordingly, the present inventors found that the alignment film A that contains a polymer containing an azobenzene group is more likely to suffer degradation of image sticking resistance in the long-term image sticking test than an alignment film that contains a polymer containing a different photo-reactive moiety.

The present inventors repeated studies and focused on a method of increasing the reactivity of a photo-reactive moiety and reducing the amount of an unreacted polymer in an alignment film by applying light under heating. The present inventors examined the optimum temperature in forming an alignment film that contains a polymer containing an azobenzene group, and found that application of light under heating at 60° C. to 80° C. can effectively improve the reactivity of the azobenzene group, thereby improving the image sticking resistance in the long-term image sticking test.

JP H11-218765 A discloses, in the paragraph [0012], a polymer film containing a polyimide polymer and a precursor thereof as main components, and discloses azobenzene derivatives, stilbene derivatives, spiropyran derivatives, a-aryl-b-Keto acid ester derivatives, calcone acid derivatives, and cinnamic acid derivatives as examples of dichroic dyes or photo-dimerizable structures. JP H11-218765 A also discloses, in the paragraph [0007], that efficient alignment can be achieved by applying linearly polarized light to a polymer film while heating the polymer film to a temperature ranging from the temperature 150° C. lower than the glass transition temperature to a temperature equal to or lower than the glass transition temperature. However, the heating temperature range disclosed in JP H11-218765 A is not examined with attention to the type of the derivative. In order to use a polymer, containing an azobenzene group as a photo-reactive moiety, as an alignment film material, additional studies need to be performed on a preferred heating temperature range.

The present inventors further found that an alignment film that contains a polymer containing an azobenzene group in a side chain is less likely to have a stable alignment ability, and also found that introduction of an azobenzene group into the main chain of a polymer constituting the alignment film can improve the alignment ability of the alignment film. Thereby, the present inventors completed the present invention.

In other words, an aspect of the present invention relates to a method for producing a substrate provided with an alignment film, the method including a film coating step in which an alignment film composition is applied to a surface of a substrate to form a film, the alignment film composition containing a first polymer that contains an azobenzene group in a main chain thereof; and a heating and exposure step in which the film is irradiated with light while the substrate is heated at 60° C. to 80° C.

The present invention can provide a method for producing a substrate provided with an alignment film whose refractive index anisotropy is less likely to change and can be maintained at a high level even during long-term use.

### BRIEF DESCRIPTION OF THE DRAWINGS

FIG. 1 is a flowchart of an exemplary method for producing a substrate provided with an alignment film of an embodiment.

FIG. 2 is a schematic view of an exemplary heating and exposure step.

FIG. 3 is a schematic cross-sectional view of an exemplary liquid crystal display device.

FIG. 4A is a schematic perspective view of a liquid crystal display device displaying a black screen.

FIG. 4B shows the superposition of the alignment azimuth of a liquid crystal molecule, the transmission axes of the front and back polarizers, and the vibrating direction of the light passed through the liquid crystal layer, seen from the front polarizer side in FIG. 4A.

FIG. 5A is a schematic perspective view of a liquid crystal display device displaying a white screen.

FIG. 5B shows the superposition of the alignment azimuth of a liquid crystal molecule, the transmission axes of the front and back polarizers, and the vibrating direction of the light passed through the liquid crystal layer, seen from the front polarizer side in FIG. 5A.

FIG. 6 is a graph of refractive index anisotropies of alignment films relative to the exposure dose in the examples and the comparative example.

FIG. 7 is a schematic view of a process of a backlight illumination resistance test.

FIG. 8 is a graph of changes in refractive index anisotropies of alignment films over time in the backlight illumination resistance test in the examples and the comparative example.

FIG. 9 is a graph of comparison of the absorbances of alignment films.

### DETAILED DESCRIPTION OF THE INVENTION

Hereinafter, an embodiment of the present invention is described. The contents of the following embodiment are not intended to limit the scope of the present invention. Any features of the embodiment may appropriately be combined or changed within the spirit of the present invention.

An aspect of the present invention relates to a method for producing a substrate provided with an alignment film, the method including a film coating step in which an alignment film composition is applied to a surface of a substrate to form a film, the alignment film composition containing a first polymer that contains an azobenzene group in a main chain thereof; and a heating and exposure step in which the film is irradiated with light while the substrate is heated at 60° C. to 80° C.

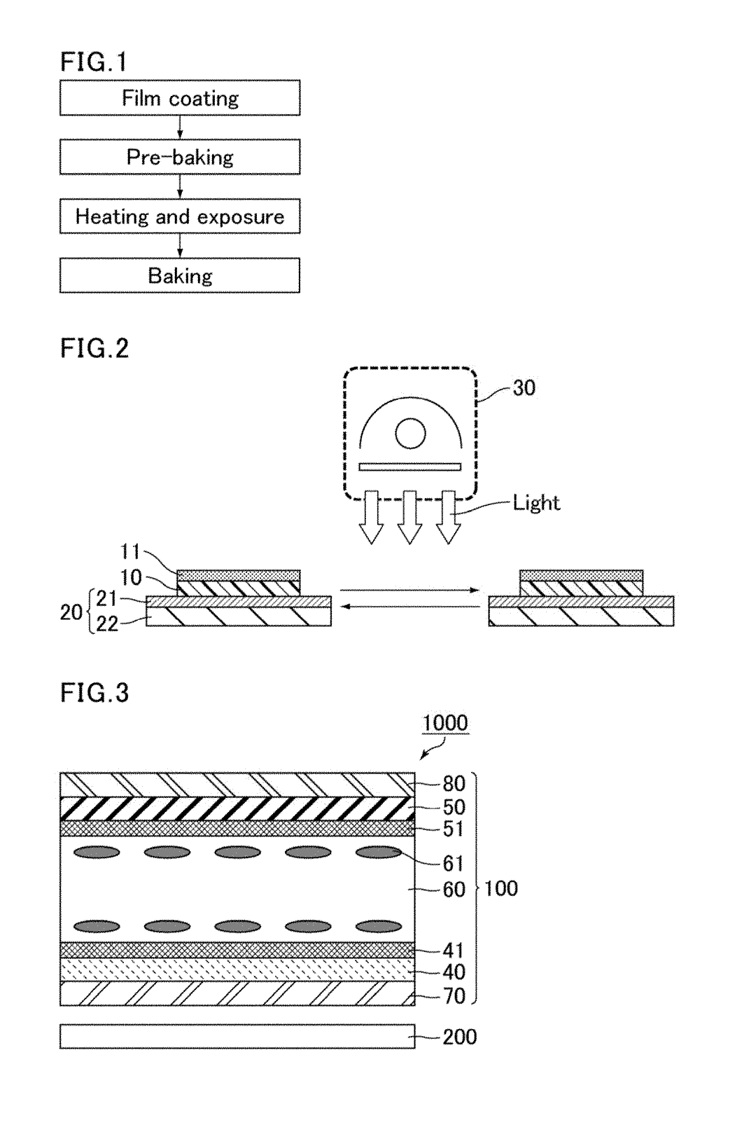

With reference to FIG. 1, the following describes an exemplary method for producing a substrate provided with an alignment film of the present embodiment. FIG. 1 is a flowchart of an exemplary method for producing a substrate provided with an alignment film of the present embodiment. As shown in FIG. 1, the method for producing a substrate provided with an alignment film of the present embodiment may include a film coating step, a pre-baking step, a heating and exposure step,. and a baking step in the stated order.

### (Film Coating Step)

In the film coating step, an alignment film composition that contains a first polymer containing an azobenzene group in the main chain is applied to a surface of a substrate to form a film. The azobenzene group contained in the first polymer as a photo-reactive moiety is isomerized when the film is irradiated with light in the heating and exposure step to be described later. Thereby, the film exhibits refractive index anisotropy.

The azobenzene group contained in the main chain of the first polymer can lead to an alignment film having a stable alignment ability. This is presumably because the light irradiation can directly change the structure of the main chain and align the directions of the first polymer molecules, so that the resulting alignment film has significantly improved refractive index anisotropy. If a polymer containing an azobenzene group in a side chain is used as a component of the alignment film composition, the resulting alignment film fails to have a stable alignment ability. This is presumably because, although not clear, even when light irradiation causes a reaction of the side chain, the main chain does not follow this reaction and the directions of the first polymer molecules are not aligned.

The first polymer may have a polyamic acid structure, a polyimide structure, a polysiloxane structure, a polyvinyl structure, or the like in the polymer main chain. In order to achieve excellent heat resistance and easy separation of layers, the polymer main chain of the first polymer more preferably has a polyamic acid structure and/or a polyimide structure. The proportion of amide groups and carboxyl groups dehydrated and cyclized by imidization among the amide groups and carboxyl groups of the polyamic acid is referred to as an imidization percentage. In the present specification, the polyamic acid structure means one having an imidization percentage of lower than 50%, and the polyimide structure means one having an imidization percentage of 50% or higher. The polyacrylic structure is degraded at high temperature and the baking temperature thereof is limited, so that the polyacrylic structure is less compatible with an azobenzene group. Thus, the first polymer preferably contains no polyacrylic structure in the polymer main chain. For the alignment film having a bilayer structure to be described later, the polyacrylic structure is less likely to allow easy separation of layers and a stable alignment ability. Accordingly, the first polymer preferably contains no polyacrylic structure in the polymer main chain.

The alignment film composition may further contain a second polymer, and the alignment film may have a bilayer structure of a photo-alignment layer containing the first polymer and placed on a surface opposite to the substrate and a base layer containing the second polymer and in contact with the substrate. The photo-alignment layer is a layer in contact with a liquid crystal layer when the substrate provided with an alignment film in the present invention is used in a liquid crystal display device. The photo-alignment layer has a role of determining the direction of aligning liquid crystal molecules contained in the liquid crystal layer and the strength of alignment (anchoring energy). The base layer is a lower layer of the alignment film, and has a role of maintaining the voltage holding ratio (VHR) of the liquid crystal layer at a high level and increasing the reliability of the liquid crystal display device when the substrate provided with an alignment film in the present invention is used in a liquid crystal display device. The bilayer structure of the alignment film can lead to a liquid crystal display device having an excellent alignment controlling force and high reliability.

The second polymer used may be any one usually used in the field of liquid crystal display devices, and may appropriately be selected in consideration of layer separability from the first polymer. The second polymer may not contain a photo-reactive moiety, and may not contain a side chain for achieving an alignment controlling force.

The second polymer preferably has a polyamic acid structure, a polyimide structure, a polysiloxane structure, a polyvinyl structure, or the like, more preferably a polyamic acid structure and/or a polyimide structure, in the polymer main chain.

The first polymer and the second polymer in the alignment film composition may give a weight ratio of 2:8 to 8:2. The larger the amount of the first polymer is, the larger the exposure dose is required to cause a reaction of the azobenzene group in the heating and exposure step. In this case, the solvent in the alignment film composition may be evaporated and therefore the reactivity of the first polymer may be reduced. Thus, in consideration of the influence of solvent evaporation, the amount of the first polymer is preferably smaller than the amount of the second polymer in the alignment film composition. The weight ratio of the first polymer to the second polymer in the alignment film composition is more preferably 3:7 to 5:5.

The substrate may be a transparent substrate made of glass such as alkali-free glass or transparent resin such as acrylic resin or cycloolefin, for example. In the case of using a substrate provided with an alignment film produced by the method for producing a substrate provided with an alignment film of the present embodiment (hereinafter, also referred to as a substrate provided with an alignment film in the present invention) for a display element such as a liquid crystal panel, the substrate may be an active matrix substrate (TFT substrate) including a transparent substrate provided with signal lines such as gate lines and source lines, thin-film transistors (TFTs), and electrodes such as pixel electrodes and common electrodes, or may be a color filter substrate (CF substrate) including a transparent substrate provided with components such as a color filter and a black matrix.

The alignment film composition may be applied by any method, such as flexography or inkjet application.

### (Pre-Baking Step)

The alignment film composition may further contain a solvent, and the method may further include, between the film coating step and the heating and exposure step to be described later, a pre-baking step in which the substrate is heated to evaporate the solvent partially and to dry the film. The pre-baking step can adjust the fluidity of the film and the state of layer separation.

Examples of the solvent include N-methyl-2-pyrrolidone (NMP), butyl cellosolve (BCS), and γ-butyrolactone. These solvents may be used alone, or two or more of these may be used in the form of a mixture.

The pre-baking step mainly has two roles of (1) improving the layer separability of the alignment film and (2) enabling the heating and exposure step to be described later with the fluidity of the polymer being maintained at a certain level.

The role (1) is described here. In the case of an alignment film having a bilayer structure, the alignment film composition contains the first polymer and the second polymer in a mixed state. They start to separate in the form of layers at the time when the alignment film composition is applied to a substrate surface. The presence of a solvent in the alignment film composition can improve the fluidity of the first polymer and the second polymer, promoting the separation of layers. If too large an amount of the solvent is present, it may cause rapid separation of the layers, resulting in aggregation of the first polymer in the form of islands on the surface of the alignment film. This may cause unevenness of the photo-alignment layer that functions to align liquid crystal molecules and appearance of part of the base layer on the surface of the alignment film, reducing the alignment controlling force of the alignment film. Thus, it is important to rapidly evaporate the solvent so as to prevent excessive separation of the layers.

The role (2) is described here. If the solvent is completely evaporated, the fluidity of the first polymer is reduced and the photo-reactivity of the first polymer in response to light irradiation in the heating and exposure step to be described later is significantly reduced. Thus, it is important not to evaporate the solvent completely but to evaporate the solvent partially and retain the solvent to the extent that the photo-reactivity of the first polymer is not impaired.

In order to achieve both of the roles (1) and (2), the substrate is preferably heated at 50° C. to 80° C. in the pre-baking step. The drying duration in the pre-baking step may be 60 to 120 seconds.

### (Heating and Exposure Step)

In the heating and exposure step, the film is irradiated with light while the substrate is heated at 60° C. to 80° C. Irradiation of the film with light causes an isomerization reaction of an azobenzene group contained in the first polymer, and thereby the film exhibits refractive index anisotropy. An alignment film that is to exhibit refractive index anisotropy by light irradiation is also referred to as a photo-alignment film. In the case of using the substrate provided with an alignment film in the present invention for a liquid crystal display device, a liquid crystal layer is formed so as to be in contact with the alignment film and the alignment azimuth (initial alignment) of liquid crystal molecules with no voltage application is controlled by the alignment film. The alignment film exhibiting refractive index anisotropy has an alignment controlling force to control the alignment of adjacent liquid crystal molecules. Thus, improving the refractive index anisotropy of the alignment film can lead to improved alignment controlling force. The initial alignment of liquid crystal molecules depends on the alignment azimuth of the first polymer constituting the alignment film. Thus, aligning the first polymer in a desired azimuth by light irradiation can set the initial alignment of liquid crystal molecules to a desired azimuth.

Setting the temperature of heating the substrate to 60° C. to 80° C. in the heating and exposure step improves the reactivity of the first polymer. This enables a sufficient alignment controlling force even with a small exposure dose. Further, exposure under heating can increase the maximum value of the refractive index anisotropy of the alignment film. Thus, when the substrate provided with an alignment film in the present invention is applied to a liquid crystal display device, a liquid crystal display device can have excellent image sticking resistance. Heating the substrate at a temperature lower than 60° C. fails to give a sufficient effect of improving the reactivity of the first polymer, so that the exposure dose needs to be increased so as to achieve a desired alignment controlling force. However, if the exposure dose is increased, the treatment duration (light irradiation duration) in the heating and exposure step is prolonged. Accordingly, the solvent in the alignment film composition tends to be evaporated, resulting in poor reactivity of the first polymer and low refractive index anisotropy. In contrast, heating the substrate at a temperature exceeding 80° C. hardly changes the refractive index anisotropy of the alignment film over time in evaluation of backlight illumination resistance. Thus, a heating temperature of 80° C. is sufficient to improve the refractive index anisotropy of the alignment film. The higher the temperature of heating the substrate is, the more the reactivity of the first polymer is improved. Still, too high a heating temperature may cause a portion where the solvent is completely evaporated in the film, so that the reactivity of the first polymer may be partially reduced. As a result, the refractive index anisotropy of the alignment film may be locally significantly reduced. Accordingly, in consideration of both improvement of refractive index anisotropy of the alignment film and bad influence of evaporation of the solvent in the film, the upper limit of the heating temperature is 80° C. The lower limit of the temperature of heating the substrate is preferably 70° C.

The reduction in reactivity due to evaporation of the solvent in the film is a phenomenon observed in a polymer containing a photo-reactive moiety that is to be isomerized by light irradiation. For a polymer containing a decomposable type photo-reactive moiety, there is no need to consider bad influence of evaporation of the solvent in the film. A polymer containing a decomposable type photo-reactive moiety can exhibit refractive index anisotropy as a result of cleavage of a bond of the photo-reactive moiety by light irradiation. Easiness of cleavage of a bond in the photo-reactive moiety depends on the degree of polymerization, such as imidization, of the main chain. Thus, there seems to be no particular reason to set the heating temperature to 80° C. or,lower in the heating and exposure step.

In the case of using the substrate provided with an alignment film in the present invention for a display element such as a liquid crystal panel including a transmissive liquid crystal display device, light is applied from a backlight behind the liquid crystal panel to the substrate provided with an alignment film in the present invention. Since the azobenzene group has a reaction region ranging broadly to the visible light region, application of light including visible light from the backlight to an unreacted azobenzene group remaining in the completed alignment film causes reduction in refractive index anisotropy of the alignment film and occurrence of image sticking during long-term use. In the method for producing a substrate provided with an alignment film of the present embodiment, the reactivity of the azobenzene group is improved and the alignment treatment is performed by the heating and exposure step in which heating is performed while light is applied. Thus, an unreacted azobenzene group is less likely to remain in the completed alignment film, reducing occurrence of image sticking during long-term use.

The light applied in the heating and exposure step is preferably linearly polarized light, and more preferably includes linearly polarized ultraviolet light.

In the heating and exposure step, light applied may be within the wavelength range of 320 to 500 nm. The azobenzene group has a broad reaction range, and thus such a wavelength range can easily promote an isomerization reaction of an azobenzene group contained in the first polymer and allows the alignment film to efficiently exhibit the refractive index anisotropy. Application of ultraviolet light at a short wavelength of shorter than 320 nm may cause not only the isomerization reaction of an azobenzene group but also a reaction of inhibiting the isomerization reaction, reducing the efficiency of exhibiting the refractive index anisotropy. The light applied may have any central wavelength as long as it is within the wavelength range of 320 to 500 nm. For example, the central wavelength is preferably 350 to 450 nm.

The light applied in the heating and exposure step more preferably includes no light at a wavelength of shorter than 300 nm. Light within the wavelength range longer than 300 nm and shorter than 320 nm may cause both the isomerization reaction of an azobenzene group and the inhibitory reaction, but light having a short wavelength of 300 nm or shorter predominantly causes the inhibitory reaction. Thus, the light more preferably includes no light at a wavelength of shorter than 300 nm.

The refractive index anisotropy of the alignment film is expressed by the difference between the refractive index in the major axis direction of the polymer constituting the alignment film and the refractive index in the minor axis direction thereof. Specifically, the refractive index anisotropy may be determined by applying light to the alignment film in the normal direction, receiving the light transmitted through the alignment film and measuring the retardation (Δnd) of the alignment film, and then dividing this value by the thickness d of the alignment film. The retardation Δnd can be measured using “Axo Scan FAA-3 series” available from AxoMetrics Inc. The thickness d can be measured by contact step height measurement using “fully automatic highly accurate microfigure measurement instrument ET5000” available from Kosaka Laboratory Ltd.

With reference to FIG. 2, the following describes a method of irradiating the film formed on the substrate surface with light while heating the substrate. FIG. 2 is a schematic view of an exemplary heating and exposure step. As shown in FIG. 2, for example, in the heating and exposure step, a substrate 10 may be placed on a stage surface 21 of a transport stage 20, the stage surface 21 may be heated with a heating mechanism 22 provided in the transport stage 20 so that the substrate 10 may be heated, and a film 11 formed on the surface of the substrate 10 may be irradiated with light applied from a polarized light irradiation mechanism 30.

The heating mechanism 22 may be any device capable of heating the substrate 10. The heating mechanism 22 is preferably a mechanism that heats the substrate 10 up to a predetermined temperature and then maintains the temperature of the substrate 10 at a constant value. An example of the heating mechanism 22 may be, but is not limited to, a mechanism including a heater configured to heat the stage surface 21, a thermometer configured to measure the temperature of the stage surface 21, and a temperature controller configured to calculate the difference between the temperature of the stage surface 21 obtained by the thermometer and the temperature setting and to supply electric power to the heater in accordance with the temperature difference.

The polarized light irradiation mechanism 30 may be any mechanism capable of applying light to the film 11, and may include a light source, a condensing mirror, a wire grid polarizer, and a wavelength-selective filter.

Examples of the light source to be used include, but are not limited to, low-pressure mercury lamps (e.g., germicidal lamps, fluorescent chemical lamps, blacklights), high-intensity discharge lamps (e.g., high-pressure mercury lamps, metal halide lamps), short arc discharge lamps (e.g., ultra-high-pressure mercury lamps, xenon lamps, mercury xenon lamps), light emitting diodes emitting ultraviolet light, and laser diodes.

Application of light to the film 11 may be performed while the substrate 10 is moved under heating. This application of light to the film 11 may be performed while the substrate 10 is moved in a reciprocating manner. Application of light to the film 11 with reciprocating motion of the substrate 10 enables efficient polarized light irradiation in a small space.

### (Baking Step)

The method for producing a substrate provided with an alignment film of the present embodiment may further include a baking step in which heating alone is performed without light irradiation after the heating and exposure step. The baking step may be performed in a multi-stage manner, and may include first baking and second baking.

The first baking can induce a re-alignment reaction of the first polymer and increase the hardness of the alignment film, for example. The re-alignment reaction is a reaction of aligning, by heating, a first polymer remaining unreacted in the heating and exposure step along the alignment direction of the first polymer aligned in a certain direction in the heating and exposure step. The heating temperature in the first baking may vary in accordance with the types of the main chains of the first polymer and the second polymer, and may be 100° C. to 180° C., for example. The heating duration in the first baking may be 5 to 60 minutes, for example.

The second baking can produce the first polymer by polymerization to form a polymer constituting the alignment film. The second baking can form a polymer main chain structure such as a polyamic acid structure, a polyimide structure, a polysiloxane structure, or a polyvinyl structure. The heating temperature in the second baking may be 140° C. to 250° C., for example. The heating duration in the second baking may be 15 to 60 minutes, for example. The second baking is preferably performed at a temperature higher than that of the first baking.

The substrate provided with an alignment film in the present invention can suitably be used as a substrate of a display element such as a liquid crystal panel. The alignment film of the substrate provided with an alignment film in the present invention has high refractive index anisotropy, and thus has an excellent alignment controlling force and can prevent occurrence of image sticking of a liquid crystal panel. In particular, the alignment film has excellent long-term stability not only at room temperature but also at high temperature, and thus is suitable for liquid crystal panels for onboard devices such as automotive navigation systems, meter panels, and dashboard cameras, and for liquid crystal panels for digital signage.

A liquid crystal panel may be produced by attaching a TFT substrate and a CF substrate each including an alignment film on a surface thereof, forming a liquid crystal layer containing liquid crystal molecules between the substrates, and providing a polarizer on the surface of each substrate opposite to the liquid crystal layer. At least one of the TFT substrate and the CF substrate may be the substrate provided with an alignment film in the present invention, but each of them may be the substrate provided with an alignment film in the present invention. Then, a backlight is provided on the back surface of the liquid crystal panel. Thereby, a liquid crystal display device is produced.

FIG. 3 is a schematic cross-sectional view of an exemplary liquid crystal display device. A liquid crystal display device 1000 includes a liquid crystal panel 100 and a backlight 200 on the back side of the liquid crystal panel 100. The liquid crystal panel 100 includes a TFT substrate 40, a CF substrate 50, a liquid crystal layer 60 containing liquid crystal molecules 61 between the substrates, a back polarizer 70 on a surface of the TFT substrate 40 opposite to the liquid crystal layer 60, and a front polarizer 80 on a surface of the CF substrate 50 opposite to the liquid crystal layer 60. The surfaces of the TFT substrate 40 and the CF substrate 50 close to the liquid crystal layer 60 are provided with alignment films 41 and 51, respectively. At least one of a stack of the TFT substrate 40 and the alignment film 41 or a stack of the CF substrate 50 and the alignment film 51 has only to be the substrate provided with an alignment film in the present invention.

The liquid crystal layer 60 may be any layer containing at least one type of liquid crystal molecules 61, and may be one usually used in the field of liquid crystal display devices. The liquid crystal molecules 61 may be of a negative liquid crystal material whose anisotropy of dielectric constant (Δε) defined by the following formula has a negative value, or may be of a positive liquid crystal material whose anisotropy of dielectric constant (Δε) has a positive value.

Δε=(dielectric constant of liquid crystal molecule in major axis direction)−(dielectric constant of liquid crystal molecule in minor axis direction)

The back polarizer 70 and the front polarizer 80 are preferably linear polarizers, and may be those usually used in the field of liquid crystal display devices. The transmission axis of the front polarizer 80 and the transmission axis of the back polarizer 70 are preferably arranged in crossed Nicols.

The backlight 200 may be one usually used in the field of liquid crystal display devices. The backlight 200 preferably emits light containing visible light (e.g., at a wavelength of 400 to 800 nm). The backlight 200 may be of a direct-lit type or an edge-lit type.

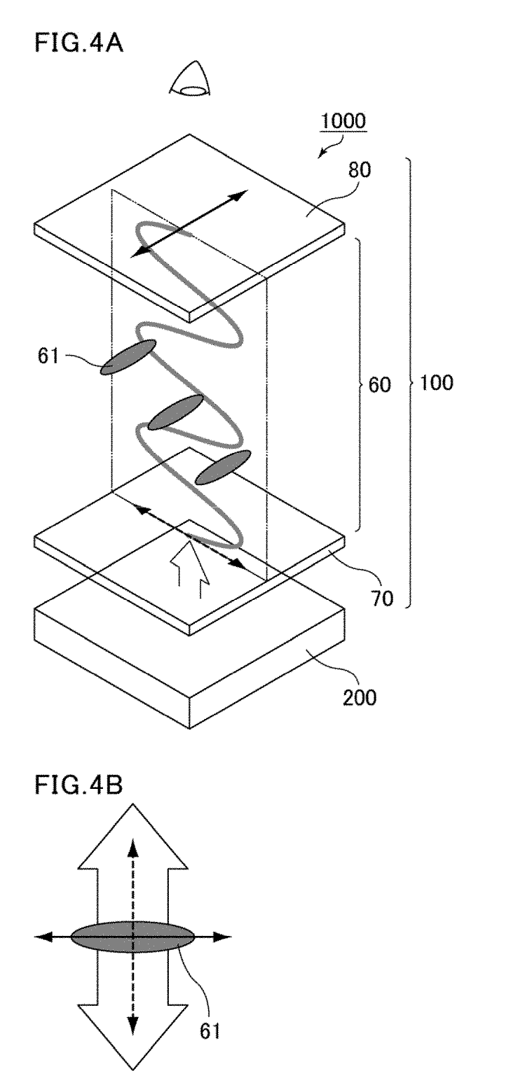

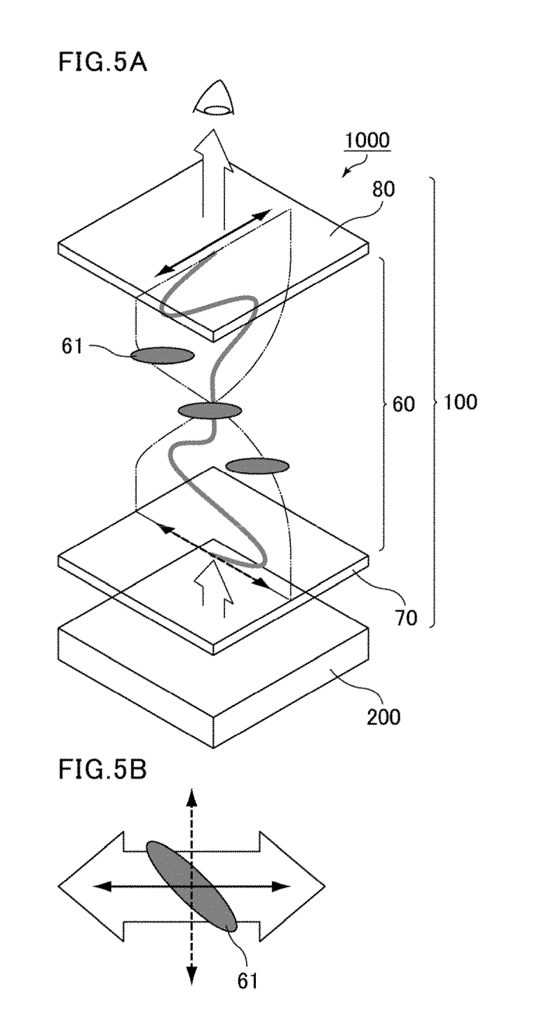

With reference to FIGS. 4A and 4B and FIGS. 5A and 5B, the following describes a display method in an exemplary case of applying the substrate provided with an alignment film in the present invention to an in-plane switching (IPS) mode liquid crystal display device. FIG. 4A is a schematic perspective view of a liquid crystal display device displaying a black screen. FIG. 5A is a schematic perspective view of a liquid crystal display device displaying a white screen. FIG. 4B and FIG. 5B respectively show the superposition of the alignment azimuth of a liquid crystal molecule, the transmission axes of the front and back polarizers, and the vibrating direction of the light passed through the liquid crystal layer, seen from the front polarizer side in FIG. 4A and FIG. 5A. For convenience of description, FIG. 4A and FIG. 5A show only the liquid crystal layer 60, the liquid crystal molecules 61, the back polarizer 70, and the front polarizer 80 as the components constituting the liquid crystal panel 100. Still, the liquid crystal panels 100 shown in these figures have the same structure as the liquid crystal panel 100 shown in FIG. 3. In FIGS. 4A and 4B and FIGS. 5A and 5B, the dashed left-right arrows each indicate the transmission axis of the back polarizer 70, the solid left-right arrows each indicate the transmission axis of the front polarizer 80, and the white left-right arrows each indicate the vibrating direction (polarized direction) of the light passed through the liquid crystal layer 60.

The vibrating direction (polarized direction) of the light emitted from the backlight 200, passed through the back polarizer 70, and incident on the liquid crystal layer 60 is parallel to the transmission axis of the back polarizer 70. As shown in FIGS. 4A and 4B, the polarized direction of light does not change in the liquid crystal layer 60 in a no-voltage-applied state in which no voltage is applied to the liquid crystal layer 60. Thus, the polarized direction of the light passed through the liquid crystal layer 60 remains perpendicular to the transmission axis of the front polarizer 80 and the light fails to pass through the front polarizer 80. Accordingly, the light from the backlight 200 is not emitted to the viewer side and a black screen is displayed. In contrast, as shown in FIGS. 5A and 5B, the liquid crystal molecules 61 rotate in the plane of the liquid crystal panel 100 and the birefringence of the liquid crystal molecules changes the phase difference in the liquid crystal layer 60, in a state of applying voltage to the liquid crystal layer 60. Thus, the polarized direction of the light incident on the liquid crystal layer 60 rotates and the light passes through the front polarizer 80. Accordingly, the light from the backlight 200 is emitted to the viewer side and a white screen is displayed. As the magnitude of the voltage applied to the liquid crystal layer 60 is changed, the degree of rotation of the liquid crystal molecules 61 can be changed, providing gray scale display. As shown in FIGS. 5A and 5B, the luminance becomes the highest when the polarized direction of the light passed through the liquid crystal layer 60 is parallel to the transmission axis of the front polarizer 80. The arrangement of the back polarizer 70 and the front polarizer 80 may be reverse to the arrangement shown in FIGS. 4 and FIGS. 5.

### EXAMPLES

The present invention is more specifically described hereinbelow with reference to examples. Still, these examples are not intended to limit the present invention.

### Example 1

In Example 1, a substrate provided with an alignment film was produced by performing a film coating step, a pre-baking step, a heating and exposure step, and a baking step (first baking and second baking) in the stated order.

### (Film Coating Step)

An alignment film composition was prepared which contained a first polymer containing an azobenzene group and a polyamic acid or polyimide structure in the main chain, a second polymer containing no side chain for achieving an alignment controlling force but containing a polyamic acid or polyimide structure in the main chain, and a solvent. In the alignment film composition, the weight ratio of the first polymer to the second polymer was 3:7. The solvent used was a solution mixture of N-methyl-2-pyrrolidone (NMP) and butyl cellosolve (BCS), and was prepared so that the solid concentration was about 6%. The alignment film composition was applied to a glass substrate by flexography, whereby a film was formed.

### (Pre-Baking Step)

In the pre-baking step, the substrate provided with the film was placed on a hot plate set to 80° C. with a 1-mm clearance present therebetween. The substrate provided with the film was heated for 90 seconds, whereby the solvent was partially evaporated and the film was dried. The surface temperature of the substrate was maintained within the range of 60° C. to 70° C.

### (Heating and Exposure Step)

In the heating and exposure step, as shown in FIG. 2, the substrate provided with the film was sucked and held on a stage surface of a transport stage provided with a heating mechanism, and the substrate was moved in a reciprocating manner below a polarized light irradiation mechanism while heated. Thereby, the film was irradiated with light, i.e., subjected to exposure. In Example 1, the heating temperature was set to 60° C. and the polarized ultraviolet light (wavelength range: 320 to 440 nm, central wavelength: 380 nm) was applied at 1000, 1500, 2000, 2500, 3000, 3500, 4000, and 4500 mJ.

### (Baking Step)

In the baking step, using a far-infrared heating furnace, first baking was performed at 175° C. for 10 minutes, and then second baking was performed at 220° C. for 20 minutes.

### Example 2

A substrate provided with an alignment film of Example 2 was produced in the same manner as in Example 1, except that the temperature of heating the substrate in the heating and exposure step was changed to 80° C.

### Comparative Example 1

In Comparative Example 1, a film was formed and pre-baked in the same manner as in Example 1, and then the substrate was irradiated with polarized ultraviolet light at room temperature (20° C. to 25° C.) without heating. Subsequently, the first baking and the second baking were performed in the same manner as in Example 1, whereby a substrate provided with an alignment film of Comparative Example 1 was produced.

### <Evaluation of Refractive Index Anisotropy of Alignment Film>

For each of the examples and the comparative example, the refractive index anisotropy (Δn) of the alignment film relative to the light exposure (unit: mJ) was determined. The substrate provided with an alignment film obtained in each of the examples and the comparative example was irradiated with light in the direction normal to the substrate. The retardation (Δnd) of the transmitted light was measured, and the resulting value was divided by the thickness (d) of the alignment film, whereby the refractive index anisotropy (Δn) was calculated. The retardation (Δnd) was measured using “Axo Scan FAA-3 series” available from AxoMetrics Inc. The thickness was measured by contact step height measurement using “fully automatic highly accurate microfigure measurement instrument ET5000” available from Kosaka Laboratory Ltd.

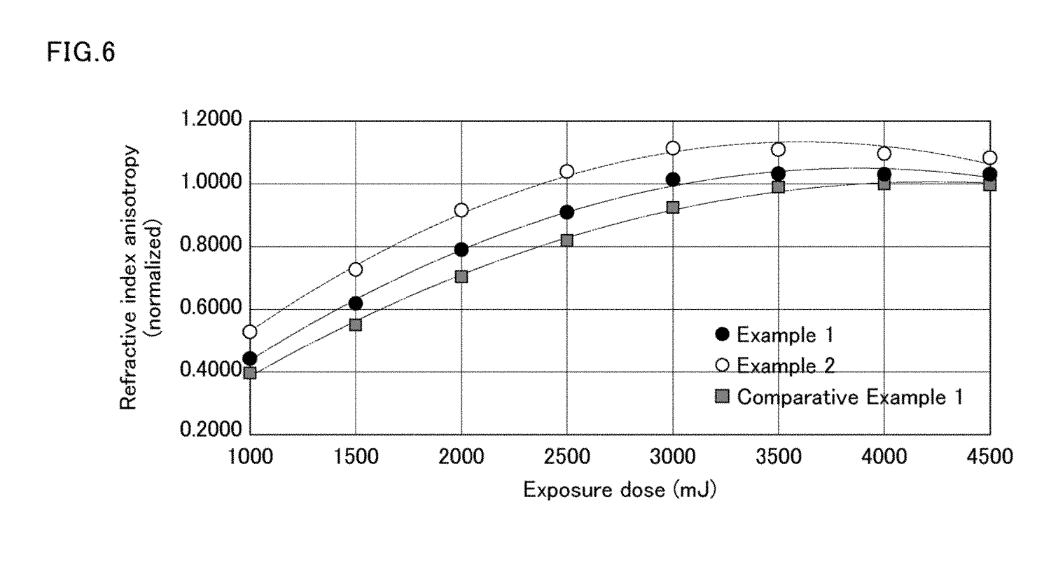

The results are shown in FIG. 6. FIG. 6 is a graph of refractive index anisotropies of alignment films relative to the exposure dose in the examples and the comparative example. In FIG. 6, the refractive index anisotropy values were normalized based on the value at which the refractive index anisotropy of the alignment film of the substrate provided with an alignment film in Comparative Example 1 reached the peak value, and this reference value was taken as “1”.

Based on the results shown in FIG. 6, the peaks of the refractive index anisotropies were first compared. The comparison shows that the peak of the refractive index anisotropy in Example 1 and the peak of the refractive index anisotropy in Example 2 were higher than that in Comparative Example 1 by about 3% and about 10%, respectively. Next, the exposure doses at the respective peaks of the refractive index anisotropies were compared. The comparison shows that the refractive index anisotropy reached the maximum with a smaller exposure dose in Example 1 than in Comparative Example 1. Specifically, in Comparative Example 1, the refractive index anisotropy reached the maximum at an exposure dose of 4000 mJ. In Example 1, the refractive index anisotropy reached the maximum at an exposure dose of 3500 mJ, which is 500 mJ lower than in Comparative Example 1. Further, in Example 2, the refractive index anisotropy reached the maximum at a lower exposure dose than in Example 1. Specifically, in Example 1, the refractive index anisotropy reached the maximum at 3500 mJ. In Example 2, the refractive index anisotropy reached the maximum at an exposure dose of 3000 mJ, which is 500 mJ lower than in Example 1.

The above results demonstrate that the heating improved the reactivity of the first polymer and sensitized the photo-alignment film. The above results further demonstrate that increasing the temperature of heating the substrate in the heating and exposure step from 60° C. to 80° C. further improved the reactivity of the first polymer and sensitized the photo-alignment film. Another examination was performed in which the heating temperature in the heating and exposure step was increased up to 85° C. to 100° C. However, this generated a portion at which the refractive index anisotropy of the alignment film was locally significantly reduced. Thus, evaluation of the refractive index anisotropy of the alignment film was not completed. Such a local reduction in refractive index anisotropy was presumably caused as follows. That is, too high a heating temperature in the heating and exposure step generated a portion at which the solvent in the film was completely evaporated, and thus the reactivity of the first polymer was partially reduced.

### <Evaluation of Backlight Illumination Resistance>

One long-term reliability test for liquid crystal panels is a long-term image sticking test in which backlight illumination is continuously applied to a liquid crystal layer while voltage is applied thereto, so that the liquid crystal layer is aged. This test is one method of evaluating the deterioration of properties in the use environment, and is a module evaluation capable of estimating deterioration of a variety of components included in a liquid crystal panel. An aging test in which a substrate provided with an alignment film is irradiated with backlight illumination, which is a simplified version of the module evaluation focusing only on the light resistance of an alignment film, can estimate the change (reduction) in alignment ability of the alignment film.

Specifically, a substrate provided with an alignment film is irradiated with backlight illumination while the transmission axis of a polarizer and the polarized direction of light (polarized ultraviolet light) applied to the alignment film are parallel to or perpendicular to each other. The “polarized direction of light applied to the alignment film” means the polarized direction of light applied to the film in the heating and exposure step. Measurement of the refractive index anisotropy of an alignment film over time enables evaluation of the image sticking resistance during long-term use. If a polymer in which a photo-reactive moiety remains unreacted is present in the alignment film after the exposure, the backlight illumination causes a reaction of the unreacted photo-reactive moiety, resulting in a change in refractive index anisotropy of the alignment film over time. Thus, the amount of change (especially, decrement) in refractive index anisotropy of the alignment film over time is preferably as low as possible between the state in which the transmission axis of the polarizer and the polarized direction of light applied to the alignment film are parallel to each other and the state in which they are perpendicular to each other. The higher the refractive index anisotropy of the alignment film is, the higher the alignment controlling force of the liquid crystal molecules is. Thus, the refractive index anisotropy of the alignment film is preferably maintained at a high level in both the state in which the transmission axis of the polarizer and the polarized direction of light applied to the alignment film are parallel to each other and the state in which they are perpendicular to each other.

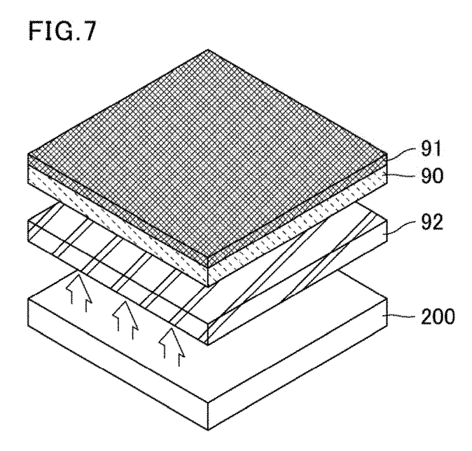

For each of the examples and the comparative example, the backlight illumination resistance was evaluated by the following method. FIG. 7 is a schematic view of a process of a backlight illumination resistance test. As shown in FIG. 7, a substrate provided with an alignment film including an alignment film 91 on a surface of a glass substrate 90 was prepared in each of the examples and the comparative example. Light was applied to the back surface of the glass substrate 90 (the surface without the alignment film 91) from the backlight 200 through the linear polarizer 92. In the evaluation of backlight illumination resistance, the substrate provided with an alignment film of each of the examples and the comparative example was irradiated with light at an exposure dose at which the refractive index anisotropy reached the peak in the evaluation of refractive index anisotropy. In other words, the substrate provided with an alignment film of Example 1, the substrate provided with an alignment film of Example 2, and the substrate provided with an alignment film of Comparative Example 1 were respectively irradiated with polarized ultraviolet light of 3500 mJ, 3000 mJ, and 4000 mJ.

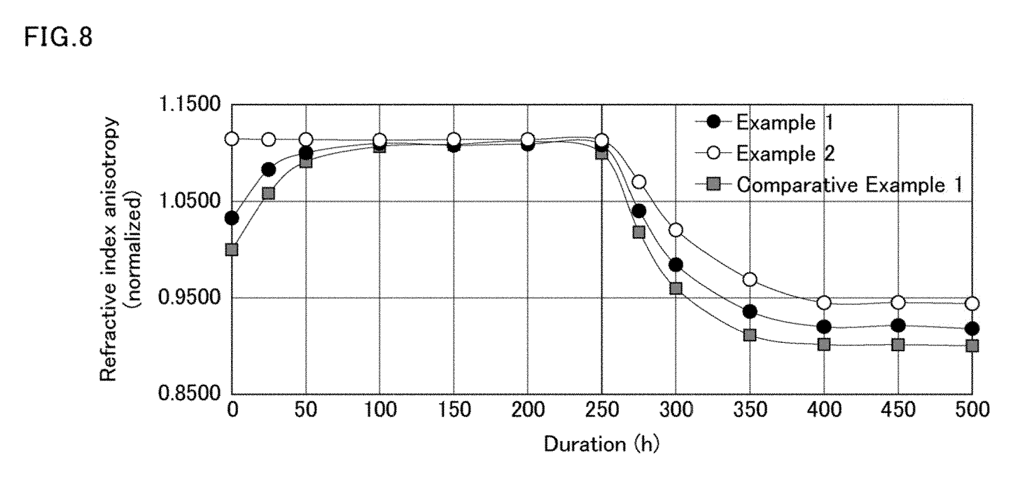

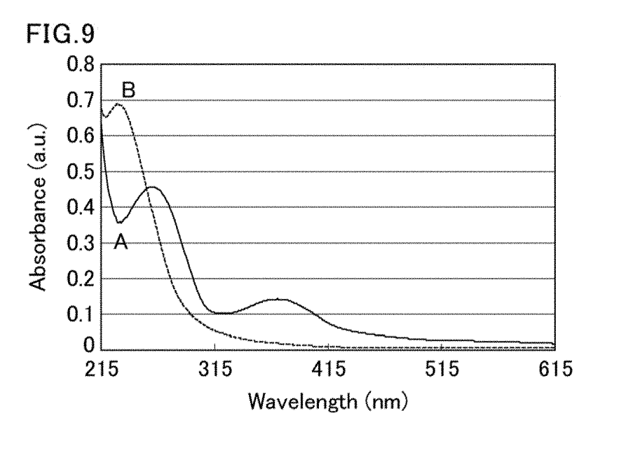

With the transmission axis of the polarizer and the polarized direction of the light applied to the alignment film being parallel to each other, the backlight illumination was applied for 250 hours and the change in refractive index anisotropy of the alignment film over time was determined. Then, the polarizer was rotated 90° so that the polarized direction of the polarizer and the polarized direction of the light applied to the alignment film were made to be perpendicular to each other. The backlight illumination was applied for 250 hours and the change in refractive index anisotropy of the alignment film over time was determined. The results are shown in FIG. 8. FIG. 8 is a graph of changes in refractive index anisotropies of alignment films over time in the backlight illumination resistance test in the examples and the comparative example.

For the amount of change in refractive index anisotropy in Comparative Example 1 in which no heating was performed in the exposure step, as shown in FIG. 8, the increment in refractive index anisotropy of the alignment film with the transmission axis of the polarizer and the polarized direction of the light applied to the alignment film being parallel to each other was about 10% relative to the initial value (0 hours), while the decrement in refractive index anisotropy of the alignment film in the perpendicular state was about 10%.

In Example 1, the increment in refractive index anisotropy of the alignment film with the transmission axis of the polarizer and the polarized direction of the light applied to the alignment film being parallel to each other was small, but the maximum value was similar to that in Comparative Example 1. Also, in Example 1, the refractive index anisotropy of the alignment film with the transmission axis of the polarizer and the polarized direction of the light applied to the alignment film being perpendicular to each other decreased over time, but the value was always higher than that in Comparative Example 1.

In Example 2, the refractive index anisotropy of the alignment film with the transmission axis of the polarizer and the polarized direction of the light applied to the alignment film being parallel to each other was hardly changed and maintained a substantially constant value. Further, the refractive index anisotropy of the alignment film with the transmission axis of the polarizer and the polarized direction of the light applied to the alignment film being perpendicular to each other decreased, but the value was always higher than not only the value in Comparative Example 1 but also the value in Example 1.

The reason why the increment in refractive index anisotropy of the alignment film with the transmission axis of the polarizer and the polarized direction of the light applied to the alignment film being parallel to each other in Example 1 was smaller than that in Comparative Example 1 is presumably as follows. That is, in Example 1, the exposure under heating seemed to increase the reactivity of the first polymer, so that the alignment film seemed to contain a smaller amount of an unreacted polymer than in Comparative Example 1 in which heating was not performed. The reason why the refractive index anisotropy of the alignment film with the transmission axis of the polarizer and the polarized direction of the light applied to the alignment film being parallel to each other in Example 2 hardly changed over time is presumably as follows. That is, in Example 2, the heating in the heating and exposure step at a temperature higher than in Example 1 seemed to further increase the reactivity of the first polymer, so that most of the polymer molecules seemed to react in the heating and exposure step. Consequently, a heating temperature of 80° C. in the heating and exposure step is sufficient to increase the refractive index anisotropy of the alignment film.

In consideration of the above results and the results in the evaluation of refractive index anisotropy of alignment film, i.e., the results that a heating temperature of higher than 80° C. generated a portion with a locally significantly reduced refractive index anisotropy in the alignment film, the upper limit of the temperature of heating the substrate in the heating and exposure step is demonstrated to be 80° C.

Also, FIG. 6 demonstrates that a continuous increase in exposure dose after the refractive index anisotropy reached the maximum in the heating and exposure step tends to slightly reduce the refractive index anisotropy. This is presumably because increasing the exposure dose seemed to prolong the treatment duration (light irradiation duration) and the solvent in the alignment film composition seemed to be evaporated, and thus the reactivity of the first polymer seemed to be slightly reduced.

### (Additional Remarks)

An aspect of the present invention relates to a method for producing a substrate provided with an alignment film, the method including: a film coating step in which an alignment film composition is applied to a surface of a substrate to form a film, the alignment film composition containing a first polymer that contains an azobenzene group in a main chain thereof; and a heating and exposure step in which the film is irradiated with light while the substrate is heated at 60° C. to 80° C.

The light applied in the heating and exposure step may be within a wavelength range of 320 to 500 nm.

The alignment film composition may further contain a second polymer. The alignment film may have a bilayer structure of a photo-alignment layer and a base layer. The photo-alignment layer may contain the first polymer and may be placed on a surface opposite to the substrate. The base layer may contain the second polymer and may be in contact with the substrate.

The alignment film composition may further contain a solvent. The method may further include, between the film coating step and the heating and exposure step, a pre-baking step in which the substrate is heated to evaporate the solvent partially and to dry the film.

The substrate may be heated at 50° C. to 80° C. in the pre-baking step.

What is claimed is:

1. A method for producing a substrate provided with an alignment film, the method comprising:
a film coating step in which an alignment film composition is applied to a surface of a substrate to form a film, the alignment film composition containing a first polymer that contains an azobenzene group in a main chain thereof; and
a heating and exposure step in which the film is irradiated with light while the substrate is heated at 60° C. to 80° C.

2. The method for producing a substrate provided with an alignment film according to claim 1,
wherein the light applied in the heating and exposure step is within a wavelength range of 320 to 500 nm.

3. The method for producing a substrate provided with an alignment film according to claim 1,
wherein the alignment film composition further contains a second polymer, and
the alignment film has a bilayer structure of a photo-alignment layer and a base layer, the photo-alignment layer contains the first polymer and is placed on a surface opposite to the substrate, and the base layer contains the second polymer and is in contact with the substrate.

4. The method for producing a substrate provided with an alignment film according to claim 1,
wherein the alignment film composition further contains a solvent, and
the method further comprises, between the film coating step and the heating and exposure step, a pre-baking step in which the substrate is heated to evaporate the solvent partially and to dry the film.

5. The method for producing a substrate provided with an alignment film according to claim 4,
wherein the substrate is heated at 50° C. to 80° C. in the pre-baking step.
